(19) United States
(12) Patent Application Publication
(10) Pub. No.: US 2012/0205355 A1
(43) Pub. Date: Aug. 16, 2012

(54) Method for producing an asymmetric diffuser using different laser positions

(76) Inventors: Jan Münzer, Berlin (DE); Thomas Podgorski, Oranienburg OT Lehnitz (DE)

(21) Appl. No.: 13/390,784

(22) PCT Filed: Aug. 17, 2009
(86) PCT No.: PCT/EP2009/060623

§ 371 Date: Apr. 27, 2012

(51) Int. Cl. B23K 26/00

(52) U.S. Cl. 219/121.71

(57) ABSTRACT

A process for producing a hole with an asymmetrical diffuser is produced. The angular position of the laser with respect to the substrate is changed discontinuously during the processing. The production of complex holes in a substrate is simplified by using a laser in five different angular positions relative to a substrate to be processed.

### CROSS REFERENCE TO RELATED APPLICATIONS

This application is the US National Stage of International Application No. PCT/EP2009/060623, filed Aug. 17, 2009 and claims the benefit thereof. All of the applications are incorporated by reference herein in their entirety.

### FIELD OF INVENTION

The invention relates to a process for producing a hole with an asymmetrical diffuser, in which process the angular position of the laser with respect to the substrate is changed discontinuously during the processing.

### BACKGROUND OF INVENTION

The use of the laser for producing holes in substrates where the laser is also moved over the surface is known.

Processes for producing holes with side-delimiting flanks are known in the prior art. By way of example, U.S. Pat. No. 6,420,677 describes a process for the laser-assisted formation of cooling air holes in turbine blades or vanes. In this case, provision is made to discharge a sequence of laser pulses onto the surface of the turbine blade or vane, wherein parts of the turbine material are vaporized such that a hole is formed along a Z axis.

### SUMMARY OF INVENTION

It is therefore an object of the present invention to specify a process of the type mentioned in the introduction, in which no damage to the hole flank occurs as a result of interaction with the laser beam.

This object is achieved by a process as claimed in the claims.

According to the invention, this object is achieved by a partial volume of the hole being formed in each of a plurality of production steps.

The dependent claims list further advantageous measures which can be combined with one another, as desired, in order to achieve further advantages.

The basic concept of the invention is therefore to divide the overall volume of the hole to be produced into partial volumes and to form these in individual production steps. The component material of some of the individual partial volumes is removed by a side flank of the hole being traced in each case with the laser beam.

Here, the laser beam is preferably oriented such that it includes an angle of greater than 8° with the traced flank. Since, during the production of the hole, the laser beam is not directed onto the component surface close to, and parallel with, the already-formed flank of the hole, an impermissible interaction between the laser beam and the flank is prevented. Furthermore, the division of the overall volume of the hole into a plurality of partial volumes allows complex hole geometries to be formed.

Instead of the laser, electron beams or the like can also be used.

According to a further embodiment of the invention, the laser beam is oriented such that it includes an angle of greater than 10° and less than 90°, preferably of greater than 15° and less than 80° and particularly preferably of greater than 20° and less than 60° with the traced flank. An angle of 9° is especially preferred.

In one development of the invention, provision is made for a pulsed laser beam to be directed onto the component surface in the hole. In this case, a laser beam with a variable pulse width can be used. The pulse width can lie in the range of 50 ns to 800 ns, preferably of 70 ns to 600 ns and in particular of 200 ns to 500 ns. A pulse width of 400 ns is especially preferred. With such a pulsed laser beam, the component material can be vaporized particularly quickly. This is particularly advantageous for the production of the diffuser.

A laser beam with a frequency in the range of 20 kHz to 40 kHz, preferably of 25 kHz to 35 kHz and in particular of 28 kHz to 32 kHz can advantageously also be directed onto the component surface.

This is particularly advantageous for the production of the diffuser.

### BRIEF DESCRIPTION OF THE DRAWINGS

FIG. 1 shows a film-cooling hole to be produced,

FIGS. 2-8 show schematic illustrations of the course of the process,

FIG. 9 shows a gas turbine,

FIG. 10 shows a turbine blade or vane, and

FIG. 11 shows a list of superalloys.

The description and the figures represent merely exemplary embodiments of the invention.

### DETAILED DESCRIPTION OF INVENTION

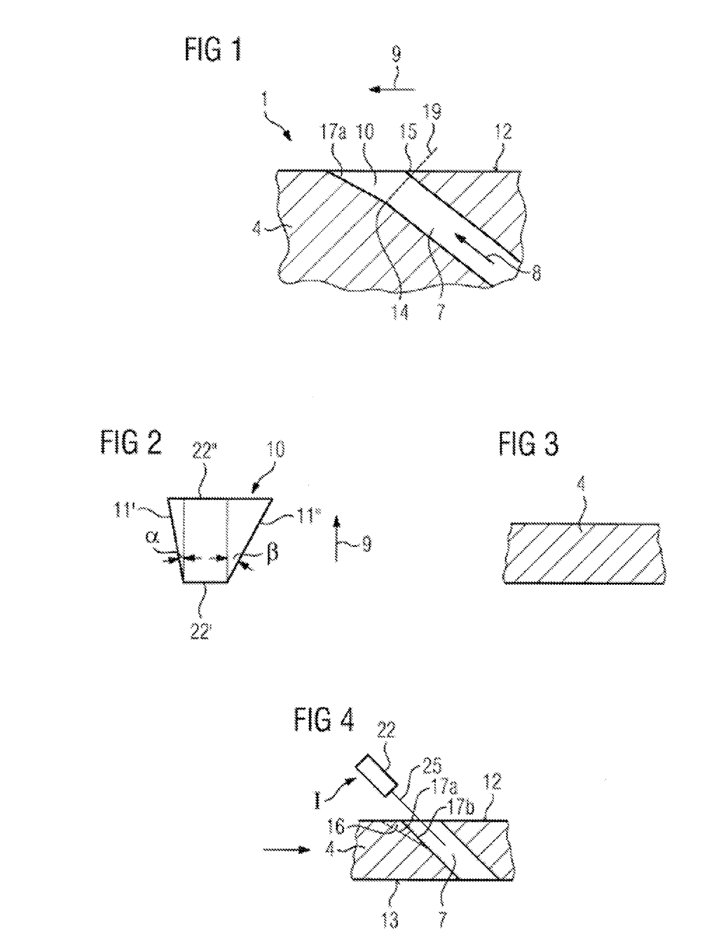

FIG. 1 shows a hole 1 in a substrate 4. The hole 1 is preferably a continuous hole, not a blind hole.

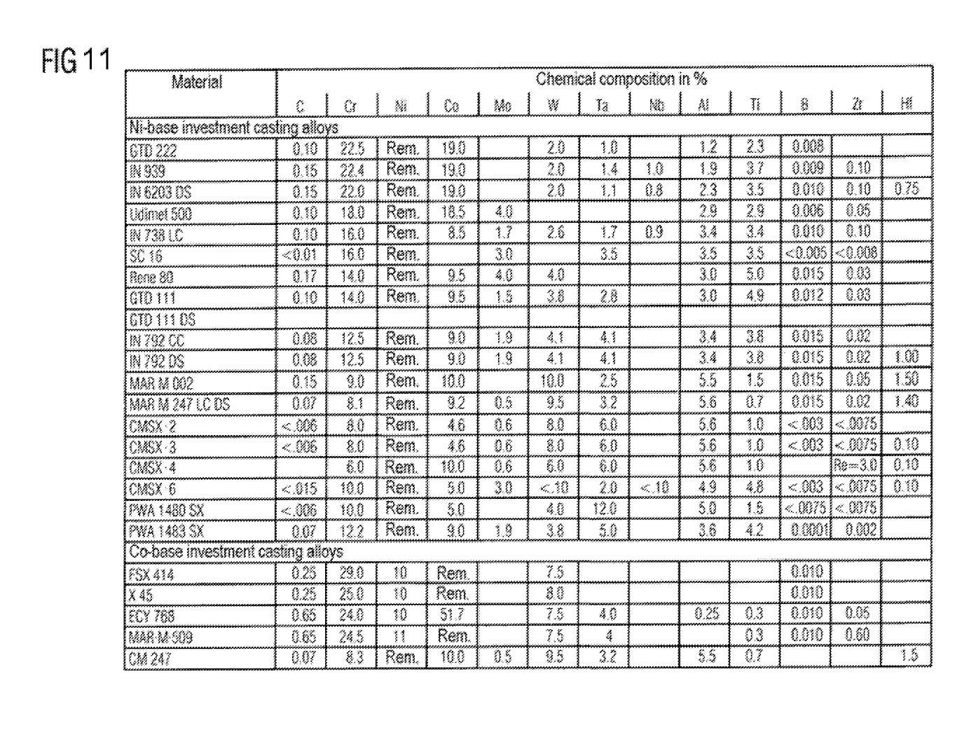

Particularly in the case of turbine blades or vanes 120, 130, the substrate 4 has a nickel-base or cobalt-base superalloy according to FIG. 11.

The film-cooling hole 1 has at least two differently configured sections 7, 10, in particular only two sections 7, 10.

The first section is an inner proportion 7, which preferably has a cylindrical or rotationally symmetrical cross section or has at least a constant cross section in an outflow direction 8.

A hot gas flows over the film-cooling hole 1 in an overflow direction 9. The outflow direction 8 of the cooling medium and the overflow direction 9 form an acute angle with one another.

From a certain depth beneath an outer surface 12 of the substrate 4 toward the surface 12, the cross section of the film-cooling hole 1 widens compared to the inner proportion 7. This represents the diffuser 10. At a kink point 14 of a left-hand surface 17a of the film-cooling hole 1, which represents the transition from the diffuser 10 to the inner proportion 7 opposite, a perpendicular line 19 on the inner surface 17a intersects an opposing section 15 in the substrate 4 at the surface 12.

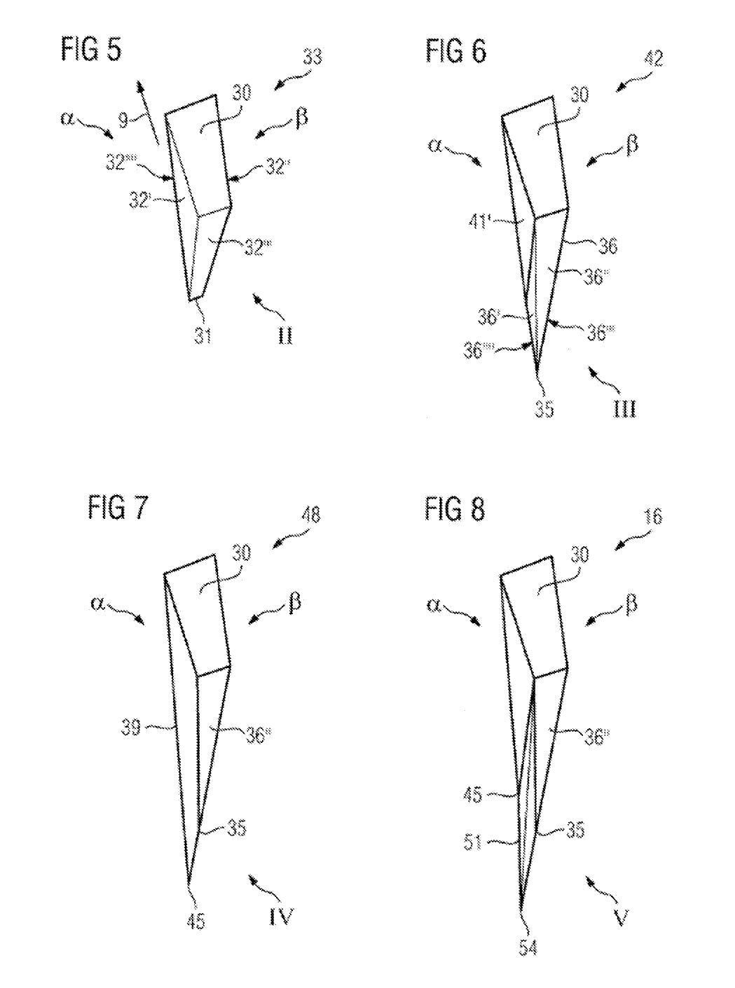

FIG. 2 is a plan view of the surface 12 with the diffuser 10 shown in FIG. 1.

In the overflow direction 9, the diffuser 10 has a front edge 22′ and a rear edge 22″ on the surface 12 (these edges are preferably rectilinear here but can also be curved).

The side flanks 11′, 11″ (these flanks are preferably rectilinear here but can also be curved) of the diffuser 10 are at two different angles α, β to the front edge 22′.

The diffuser 10 is widened transversely to the overflow direction 9 and, with respect to the extension of the inner proportion 7 which is indicated by dashed lines, has flanks 11′, 11″ which are at two different angles α and β.

Preferably, α<β; α, β<90°.

FIGS. 3-8 show the schematic course of the process for producing the hole 1.

The processing is preferably effected by trepanning.

The process begins with the provision of the substrate 4 (FIG. 3), which is then processed using a laser 22 or electron beam source in a first angular position (I), preferably the first laser position (I) (FIG. 4).

In the text which follows, the laser is used by way of example as the processing machine.

In this case, the inner proportion 7 is produced from the surface 12 as far as the opposing inner surface 13 of the substrate 4 (in the hollow space) (FIG. 4).

Here, the laser 22 preferably does not have to be moved (percussion). In the process, a remnant 16 remains in order to finish the diffuser 10 (FIG. 4). The inner proportion 7 is finished.

FIG. 8 shows the region 16 which is still to be removed (FIG. 4) after production of the inner proportion 7.

This volume 16 to be removed is preferably removed in four partial steps.

FIGS. 5 to 8 show the removal of the remnant 16. α and β denote the orientation of the remnant 16 in terms of the angles α and β (FIG. 2).

The first volume 33 of the remnant 16 which is to be removed is shown in FIG. 5.

The first partial volume 33 represents a polyhedron with a quadrangular base face 30 (at the top in the drawing), two triangular side faces 32′, 32″ and two opposing quadrangles 32′″, 32″″ as side faces.

FIG. 5 also shows the overflow direction 9, which runs over the base face 30, i.e. the base face 30 is closest to the surface 12.

The face 32″″ lies on the inner surface of the diffuser 10. This partial volume 33 is produced in the second laser position II, which differs from the first laser position I.

The edge 31″″, which is formed by the side faces 32′″, 32″″, is oriented toward the interior of the inner proportion 7. The partial volume 33 is a pentahedron (five-sided polyhedron).

In a third step, which is shown in FIG. 6, a further partial volume 36 is removed.

The second partial volume 36 to be removed adjoins the front quadrangle face 32′″ shown in FIG. 5, the partial volume 36 likewise representing a polyhedron with a quadrangular base face (=face 32′″), which represents the contact face with the polyhedron 33, and four triangular faces 36′, 36″, 36′″, 36″″. The partial volumes 33 and 36 give a partial volume 42, which represents a quadrangular base face 30 with 4 triangular side faces 41′. The partial volume 36 has a tip 35.

Both the partial volume 36 and the partial volume 42 (=33+36) represent a pentahedron.

This partial volume 36 is produced in the second laser position III, which differs from the first laser position II.

FIG. 7 shows how a third partial volume 39 is produced adjoining the partial volumes 33, 36 or partial volume 42 according to FIGS. 5 and 6.

This gives the partial volume 48.

In this case, a partial volume 39 is removed in a fourth laser position IV, which 39 adjoins the left-hand side face 41′ of the polyhedron 42 (FIG. 6), i.e. the side with the smaller angle α.

The laser position IV differs from the laser position III and in particular also from the laser positions I, II.

The base face of the partial volume 39 is triangular and adjoins the contact face 41′ of the polyhedron 42, where the tip 35 of the partial volume 36 has been extended to the tip 45, and gives a new partial volume 48.

In a new, changed fifth position V (FIG. 8), a further partial volume 51 is removed, such that the region 16 to be removed has been removed completely.

By virtue of the partial volume 51, the tip 54 thereof is extended in turn with respect to the tip 45 and adjoins the flank of the diffuser with the smaller angle a.

The laser position V preferably differs from the laser position IV and preferably also from the laser positions I, II, HI.

The film-cooling hole 1 can also be produced in the manner described above if a metallic bonding layer, preferably of the MCrAlY type, and/or a ceramic layer is present on said layer or the substrate 4.

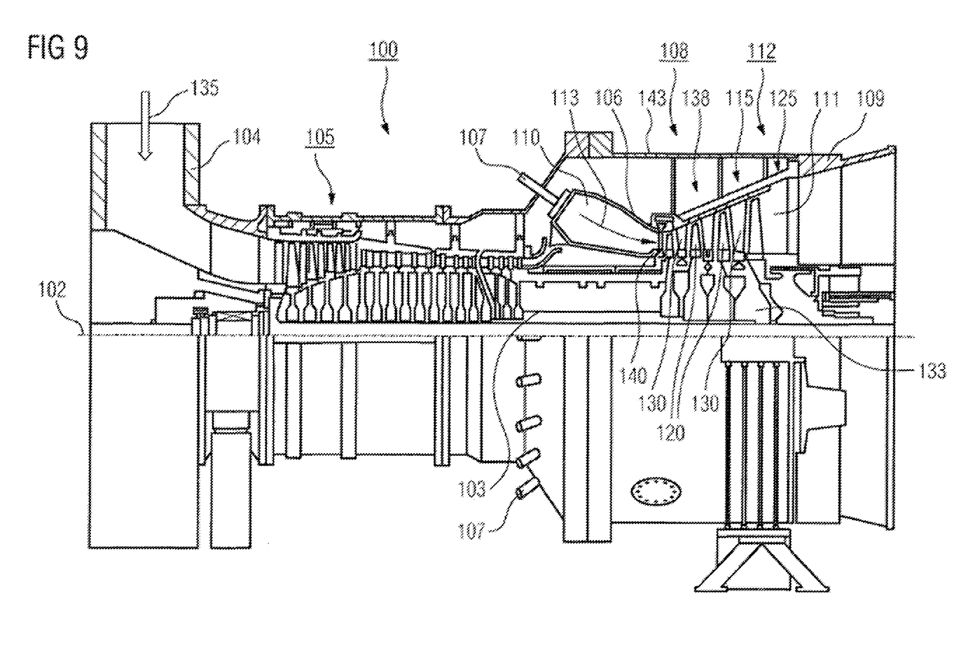

FIG. 9 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron

(Fe), cobalt (Co), nickel (Ni), X is an active element and stands for yttrium (Y) and/or silicon, scandium (Sc) and/or at least one rare earth element, or hafnium).

Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

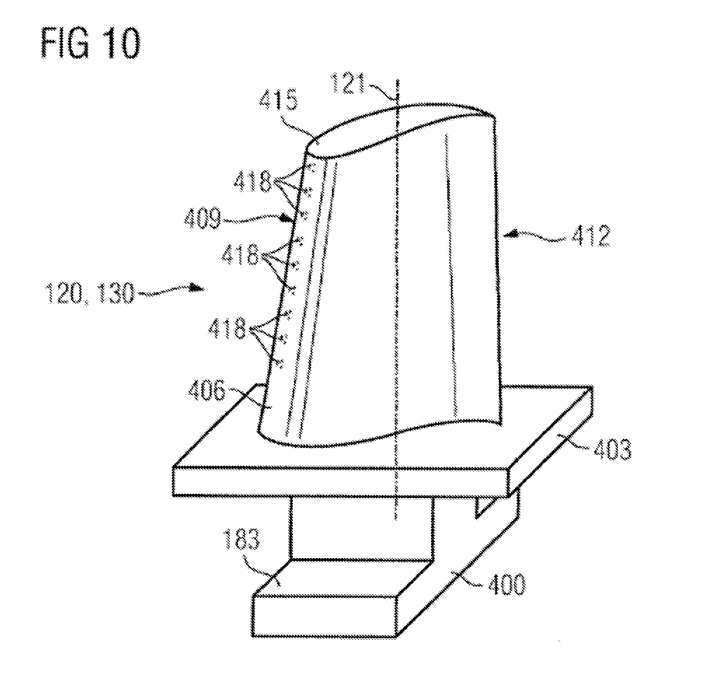

FIG. 10 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8A1-0.6Y-0.7Si or Co-28Ni-24Cr-10A1-0.6Y. In addition to these cobalt- base protective coatings, it is also preferable to use nickel-base protective layers, such as Ni-10Cr-12A1-0.6Y-3Re or Ni-12Co-21Cr-11A1-0.4Y-2Re or Ni-25Co-17Cr-10A1-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1-27. (canceled)

28. A process for producing a complex hole in a substrate, comprising:
providing the hole having an inner proportion which is symmetrical and a diffuser which is asymmetrical;
using a laser for producing the inner proportion and diffuser; and
changing the angular position of the laser with respect to the substrate only five times,
wherein a first cross section of the diffuser differs from a second cross section of the inner proportion.

29. The process as claimed in claim 28,
wherein the inner proportion of the hole is produced first,
wherein a part of the diffuser is also produced at the same time as the inner proportion,
wherein a remnant which still remains is removed in four partial steps, in order to produce the diffuser.

30. The process as claimed in claim 28, wherein the laser is not moved for the production of the inner proportion or in a first angular position.

31. The process as claimed in claim 29,
wherein the laser is moved during the production of the diffuser,
wherein the laser is moved in at least one of four angular positions, a second angular position, a third angular position, and/or a fourth angular position, and
wherein the laser is moved over an inner flank of the remnant.

32. The process as claimed in claim 29,
wherein a pulsed laser beam is used for producing the diffuser or removing the remnant in the second angular position, third angular position, fourth angular position or fifth angular position.

33. The process as claimed in claim 28, wherein only one laser is used.

34. The process as claimed in claim 28, wherein at least two lasers are used, the two lasers having different performance features.

35. The process as claimed in claim 31,
wherein a five-sided polyhedron is removed in a first step for producing the diffuser in the second angular position, third angular position, fourth angular position or fifth angular position.

36. A process for producing a complex hole in a substrate, comprising:
producing an inner proportion of the hole first; and
producing a part of the diffuser at the same time as the inner proportion,
wherein the hole is a continuous hole,
wherein a remnant which still remains is removed in only four partial steps in order to produce the diffuser.

37. The process as claimed in claim 36,
wherein a laser is used four times for removing the remnant, and
wherein the angular position of the laser with respect to the substrate is changed four times.

38. The process as claimed in claim 36,
wherein in each of a plurality of production steps a partial volume of the remaining remnant is formed by tracing one side flank of the remnant of the diffuser with the laser beam, and
wherein the laser beam is oriented such that it includes an angle of greater than 8° with the traced flank.

39. The process as claimed in claim 38,
wherein the laser beam is oriented such that it includes an angle of greater than 10° and less than 90° with the traced flank.

40. The process as claimed in claim 36,
wherein a laser beam with a variable pulse width is used for producing the diffuser or removing the remnant in the second angular position, third angular position, or fourth angular position.

41. The process as claimed in claim 40, wherein a laser beam having a pulse width in the range of 50 ns to 800 ns is used.

42. The process as claimed in claim 41, wherein a laser beam with a frequency in the range of 20 kHz to 40 kHz is used.

43. The process as claimed in claim 36,
wherein a cooling air hole is formed in a turbine blade or vane in the second, third, or fourth angular position, and
wherein the geometry of the diffuser differs significantly from the inner proportion, and
wherein the cross section of the diffuser increases compared to that of the inner proportion.

44. The process as claimed in claim 36, wherein different laser parameters are used for the production of the diffuser or the removal of the remnant than for the production of the inner proportion.

45. The process as claimed in claim 36, wherein a tip of the removed region lies further in the interior of the hole.

46. The process as claimed in claim 36,
wherein the diffuser includes two flanks at the surface of the substrate which diverge at two different angles (α, β), and
wherein α<β.

47. The process as claimed in claim 46,
wherein the material of the remnant on the side with the greater angle is removed first, and
wherein in the third and fourth steps the material of the remnant which adjoins the smaller angle is removed.
